(19) United States
(12) Patent Application Publication
(10) Pub. No.: US 2007/0166042 A1
(43) Pub. Date: Jul. 19, 2007

(54) Multiservice optical communication

(76) Inventors: Alwyn John Seeds, London (GB); Peter Hartmann, Wangs (CH); Richard Vincent Penty, Litlington (GB); Ian Hugh White, Madingley (GB)

Correspondence Address: GOODWIN PROCTER LLP;PATENT ADMINISTRATOR, EXCHANGE PLACE, BOSTON, MA, 02109-2881, US

(21) Appl. No.: 10/584,392

(22) PCT Filed: Dec. 17, 2004
(86) PCT No.: PCT/GB04/05287

§ 371 Date: Feb. 22, 2007

(30) Foreign Application Priority Data
Dec. 23, 2003 (GB) 0329908.8

(51) Int. Cl. H04B 10/12

(52) U.S. Cl. 398/142

(57) ABSTRACT

A method is provided for the transmission of digital and radio frequency signals, for example for multiservice applications, over all types of multimode optical fibre link using laser diodes. The method comprises launching optical radiation into the core of the multimode optical fibre, in a manner that restricts the number of excited modes within it. The subset of modes that are excited suppress additional noise due to the presence of a multiplicity of signals, and ensure high quality transmission.

The invention relates to a method of optical communication using a multimode fibre, to an optical communication system and to a device for coupling combinations of modulated radio frequency signals and/or baseband signals into a multimode fibre.

A typical area of application is to optical communication systems involving multimode fibres installed in or connecting compartmented spaces such as residential buildings, corporate office buildings, shopping centres, subways and airports.

There is currently much interest in the implementation of in-building RF (radio frequency) coverage both for wireless LAN (local area network) and cellular systems. Here network operators and building owners who wish to deploy cellular radio or wireless LAN systems need to be able to transmit signals around buildings from base stations to required antennas. Currently such transmission occurs over separate cable systems using twisted pair, coaxial cable or for longer lengths optical fibres as the transmission medium.

Recently however there has been much interest in the potential of using existing installed base fibre plant already used for digital transmission to additionally transmit wireless LAN or cellular signals. Such systems would allow operators to avoid installing separate cabling for the new wireless services even if the existing plant is being used for conventional systems, greatly reducing installation cost.

In designing such “multiservice” systems able to transmit both base-band data links and wireless RF modulated signals, emphasis must be placed on ensuring high quality transmission over multimode optical fibre as this class of fibre accounts currently for the great majority of fibres installed in buildings. Whilst this fibre has a limited typical bandwidth under standard overfilled launch applications, a series of studies have shown that enhanced transmission lengths can be achieved by virtue of the existence of a “flat band” transmission window beyond the 3 dB transmission frequency [Wake et al, Electronics Letters, vol.37, pp. 1087-1089, 2001]. This has made possible the transmission of up to 256 QAM (quadrature amplitude modulation) signals at 2 GHz carrier frequency over multimode fibre link lengths in excess of 1 km, well beyond the 250 m set by the fibre bandwidth. However the operation of links for RF transmission beyond the fibre bandwidth needs careful control of launch as the links are susceptible to fading due to nulls in the fibre response resulting from mode beating.

Standard launches of light from focussed laser based sources into multimode optical fibre typically involve centre launching. Here the optical power from the signal transmitter is coupled into a few central (low order) fibre modes using standard connectors and uniters. These modes can beat strongly, creating nulls which result in poor RF transmission. Alternatively, offset launch, where the optical power is coupled into the higher order modes away from the fibre centre results in fewer nulls in the optical fibre frequency response and has been shown to enable greatly enhanced RF performance suppressing the fading problems often observed in centre launch [UK patent application no. 0229238.1 “AN OPTICAL COMMUNICATION SYSTEM”]. Such offset launches have been shown also to enhance the 3 dB bandwidth, as exemplified by the published PCT patent specification no. WO97/3330 entitled ‘MULTIMODE COMMUNICATIONS SYSTEMS (HEWLETT PACKARD COMPANY)’. This approach has been adopted by the IEEE 802.3 Gigabit Ethernet Standard to guarantee the specified (over-filled launch) bandwidth by enhancing the performance of some fibres that would otherwise have low bandwidth using conventional launch conditions.

Embodiments of the present invention allow simultaneous transmission of baseband datacommunication signals (for example Gigabit Ethernet signals) and RF signals such as WLAN (wireless local area network) or cellular signals over conventional multimode optical fibre. Whilst initial measurements [Schuh et al, Proceedings PIMRC 2002, Lisbon, Portugal] of simultaneous transmission using newly developed optical fibre have been conducted, the applicants have discovered a new phenomenon of additional noise being created during simultaneous transmission in conventional multimode optical fibres excited by standard launches.

The key feature of embodiments of the present invention is the realisation of a technique whereby simultaneous transmission of baseband and RF signals can be achieved over general multimode optical fibres, such as those found in the installed base, where this additional noise is suppressed.

The approach in these embodiments applies to the enhancement signal transmission under combined transmission where signal beating can be expected.

According to one aspect of the invention there is provided a method of optical communication using a multimode fibre, the method comprising: using one or more optical radiation transmitters, coupling optical radiation into the multimode fibre using a launch which restricts the number of modes excited in the fibre such that background noise is suppressed in the demodulated signals, wherein the, or each, optical radiation transmitter is a single- or multi- transverse mode laser transmitter driven by a combination of modulated radio frequency signals and/or baseband signals.

In an embodiment, the coupling step comprises a launch which is co-linear but at an offset to the fibre axis.

In an embodiment, the or each laser transmitter has a linear frequency response whereby it is responsive to both base band and rf inputs.

According to another aspect of the invention there is provided an optical communication system comprising: one or more optical radiation transmitters; a means of coupling optical radiation from the, or each, optical radiation transmitter into a multimode fibre using a launch which restricts the number of modes excited in the fibre such that background noise is suppressed in the demodulated signals; and a photodetector; wherein the, or each, optical radiation transmitter is a single- or multi-transverse mode laser transmitter arranged to couple transmission signals into the multimode fibre which signals are combinations of modulated radio frequency signals and/or baseband signals.

In an embodiment, the means of coupling light into the fibre produces a launch which is co-linear but at an offset to the fibre axis.

In an embodiment, the fibre has a core diameter of 62.5 μm and where the offset distance measured from the centre of the multimode fibre core to the centre of the optical radiation emitted from the transmitter is from approximately 10 μm to approximately 25 μm.

In an embodiment, the or each laser transmitter has a linear frequency response whereby it is responsive to both base band and rf inputs.

According to a further aspect of the invention there is provided a device for coupling combinations of modulated radio frequency signals and/or baseband signals into a multimode fibre using a launch which restricts the number of modes excited in the fibre such that background noise is suppressed in the demodulated signals, the device comprising at least one optical radiation transmitter having a single- or multi-transverse mode laser transmitter and drive circuitry having a first input port for modulated radio frequency signals and a second input port for baseband signals, the drive circuitry being arranged to receive electrical modulated radio frequency signals and/or baseband signals and to drive the laser transmitter therewith .

In an embodiment, there is provided an optical connector for coupling light into said fibre to produce a launch which is co-linear but at an offset to the fibre axis.

In another embodiment, there is provided a direct offset from an optical source into the fibre without going via a connector.

In an embodiment for a fibre having a core diameter of 62.5 μm, the connector is arranged to provide an offset distance measured from the centre of the multimode fibre core to the centre of the optical radiation emitted from the transmitter between approximately 10 μm and approximately 25 μm.

In an embodiment, the at least one laser transmitter has a linear frequency response whereby it is responsive to both base band and rf inputs.

In a yet further aspect of the invention there is provided an optical communication system where an alternative launch technique is used to restrict the excited fibre modes to ensure high quality multi-service transmission.

In a further aspect of the invention there is provided a method of splitting the optical signal so that it may be transmitted over two or more multimode fibres and be presented to two or more antenna units in a radio system downlink.

In a further aspect of the invention there is provided a method of combining the optical signals on separate multimode fibres from two or more antenna units onto a single multimode fibre in a radio system uplink.

The present invention will now be described more particularly with reference to the accompanying drawings which show, by way of example only, an optical communication system embodying the invention.

In the drawings:

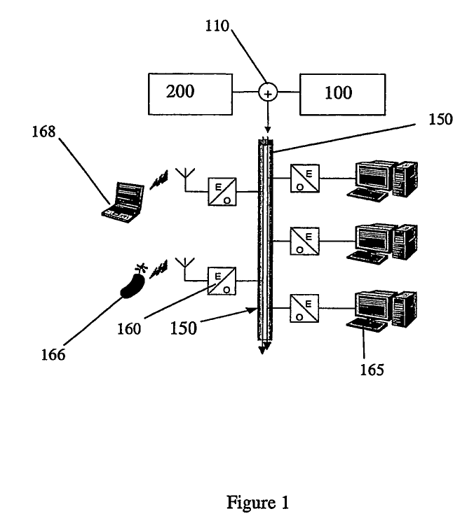

FIG. 1 shows a schematic diagram of fibre-optic system, embodying the present invention;

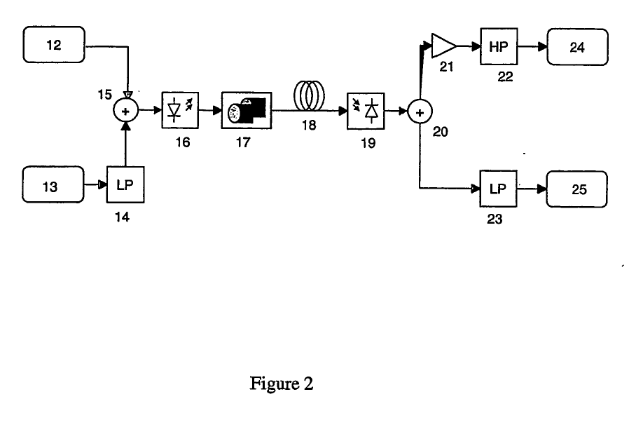

FIG. 2 shows a schematic diagram of an experimental set-up of a fibre-optic link embodying the present invention;

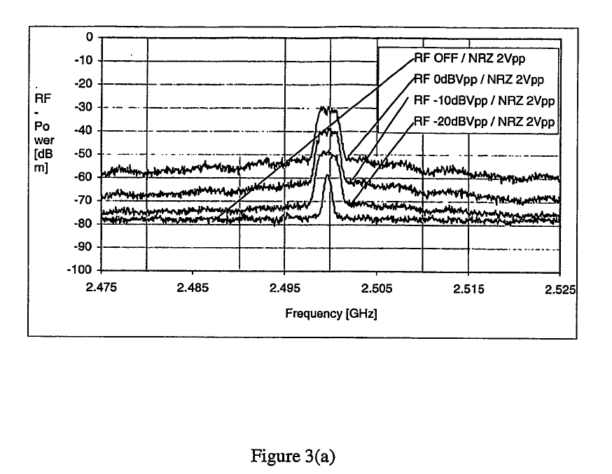

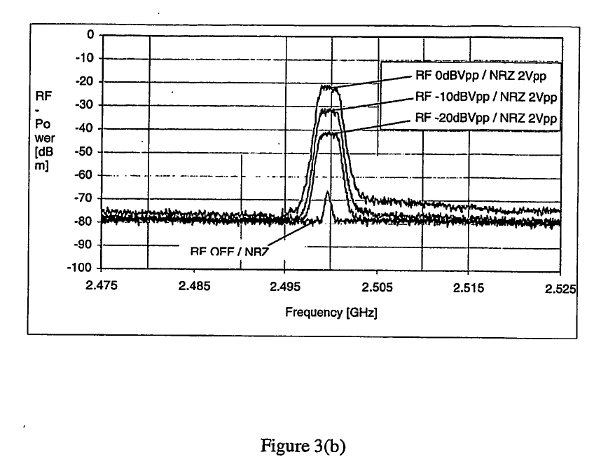

FIG. 3 (a) shows the electrical spectrum of the output of the fibre of FIG. 2 using centre-launch;

FIG. 3(b) shows the electrical spectrum of the output of the fibre of FIG. 2 using offset-launch;

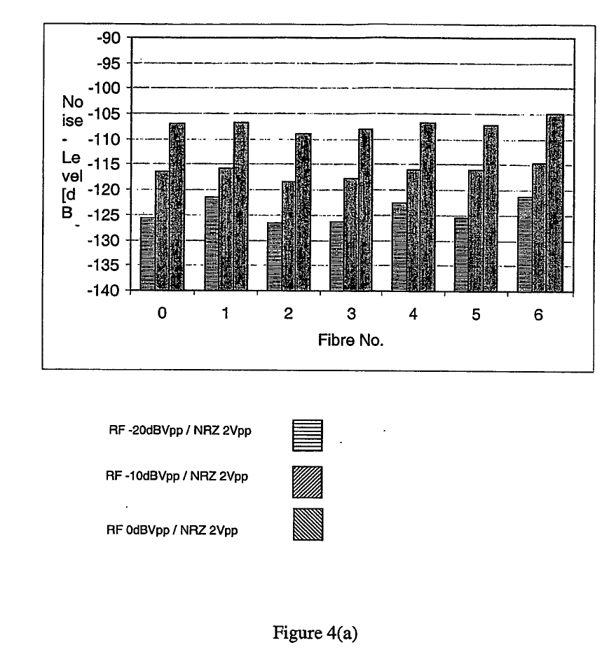

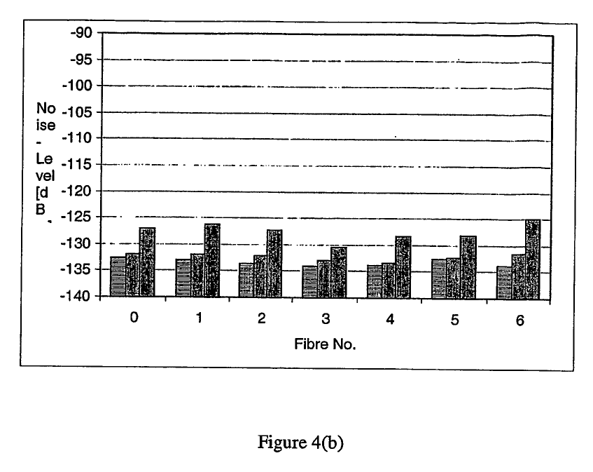

FIG. 4(a) shows noise performance of the fibre for centre launch, and FIG. 4(b) for offset launch;

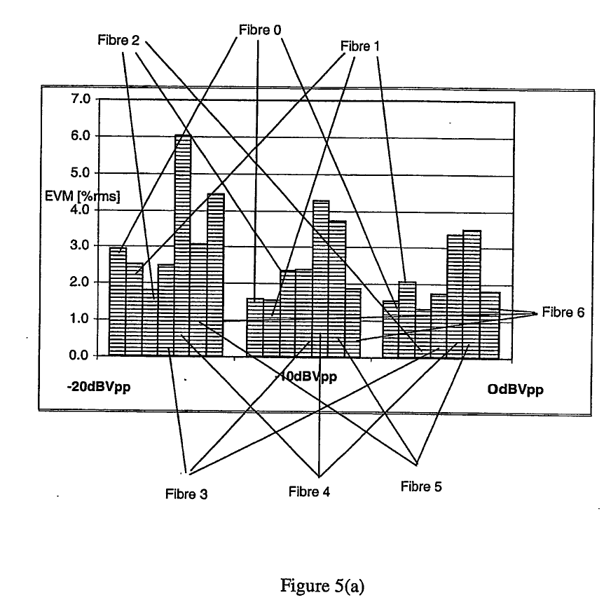

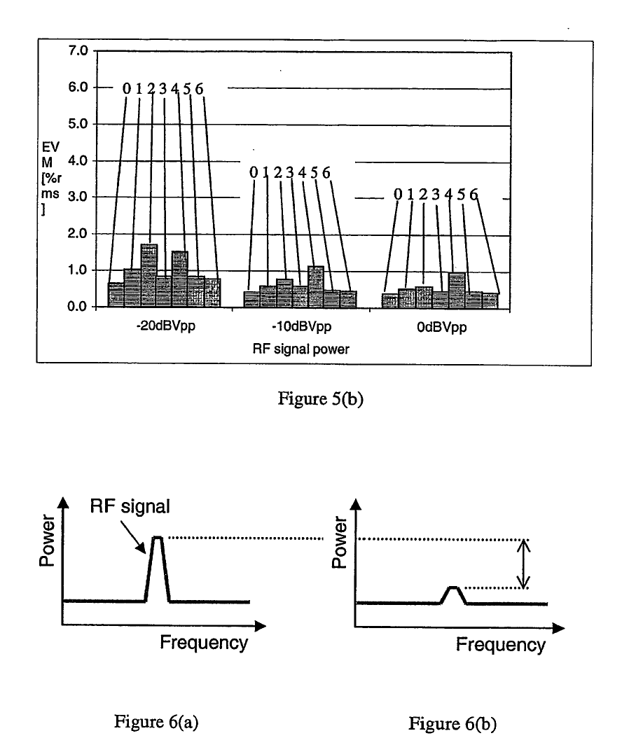

FIG. 5 (a) shows the error vector magnitude (EVM) measurements for a range of RF signal powers for the fibre (18) using centre launch;

FIG. 5(b) shows the error vector magnitude (EVM) measurements for a range of RF signal powers for the fibre (18) using offset launch;

FIG. 6 illustrates signal amplitude drop in a single-service RF fibre-optic system using centre launch;

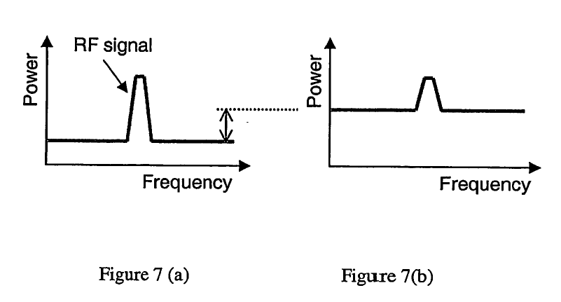

FIG. 7 illustrates noise power increase in a multi-service fibre-optic system using centre launch;

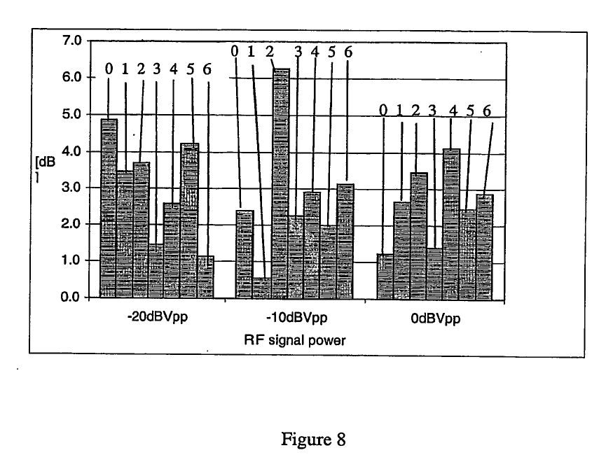

FIG. 8 presents measurements indicating the improvement in digital transmission due to the restricted launch technique;

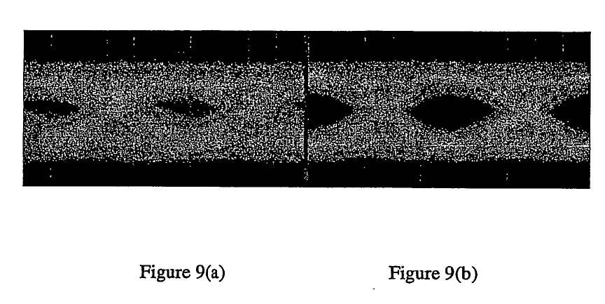

FIG. 9(a) shows measured eye-diagrams using centre launch; and

FIG. 9(b) shows measured eye-diagrams using offset launch.

FIG. 1 shows an exemplary schematic diagram of a fibre-optic system, in a building, simultaneously carrying data of two types namely baseband digital services (100) and RF modulated cellular and wireless services (200). The optical signals may be either generated simultaneously by a single source, or multiple sources. In the embodiment shown, second/third generation mobile telephone signals and “WiFi” wireless LAN signals form the RF modulated cellular and wireless services (200) and Ethernet and Gigabit Ethernet (GbE) signals form the baseband services (100). These signals are combined in an electrical combiner (110) and transformed into optical signals (120) for launch into the fibre (150). Opto-electrical devices (160) transform the optical signals to the electrical domain for distribution to various “consumers” including computers (165) via wired connections and mobile telephones (166) and laptop computers (168) via wireless connections. For data flow in the other direction from the “consumers”, in this embodiment a separate fibre is provided. FIG. 2 shows experimental apparatus (1) set up to identify a major problem in achieving reliable simultaneous transmission and to demonstrate the success of the invention in overcoming this limit. An NRZ baseband signal from a first source (13) and a low pass filter (14) was combined in a combiner (15) with a 32-QAM (quadrature amplitude modulation) RF signal from a second source (12) for simultaneously transmission over a length of multi mode fibre (18). 32-QAM encodes 5 bits into one symbol by varying the amplitude and phase of the carrier signal. This QAM modulation scheme was chosen as it is representative of modulation schemes employed in cellular and wireless communication systems. Further it requires very high signal-to-noise-ratio (SNR) for low error performance and therefore provides a good test of the overall link performance.

A range of six different worst case multi mode fibre samples was tested, and the transmission performance analysed in terms of launch condition and signal powers.

The apparatus of FIG. 2 has a single transverse mode laser (16) forming an optical radiation source, and operating at 1300 nm wavelength. The laser (16) is a broad band linear device capable of operating at both the baseband frequency and at the RF. The light beam from the laser is delivered through a single-mode fibre pigtail to a multi mode fibre (18).

A receiving element (19) consisting of a photodetector and an amplification stage was used to convert the low intensity modulated light at the fibre output back into an electrical signal. The photodetector is a broadband photodiode (19), with the photodiode having a multimode fibre input. The amplification stage is a high gain electrical preamplifier.

A signal separator (20) receives the output from the amplifier. The separator splits the output into two channels, passing one to an rf amplifier (21) whose output is coupled via a High-pass filter (22) to a signal analyser (24). The signal analyser has a signal generator for generating a 32-QAM signal at a centre frequency of 2.5 GHz with a symbol rate of 2Ms/s.

The second channel is passed to a low pass filter (23) and to a second signal analyser (25) for analysing the NRZ baseband signals.

A precision xyz-stage (17) is used to control the launch conditions into various combinations of reels of ‘worst-case’ multimode fibre (typical of the worst fibres believed currently to be installed in the field) with a diameter of 62.5 microns and a numerical aperture of 0.28. A series of fibres were tested, these being the same as used for the standardisation of the offset launch technique described in the Gigabit Ethernet standard, IEEE 802.3z, 1998. Therefore all fibres had bandwidths near the specified limit of 500 MHz.km at 1300 nm wavelength. The transmission performance is analysed in terms of launch condition and transmitted signal powers.

FIG. 3(a) shows modulation spectra of the RF signal, for light is launched centrally into the fibre, at the output after transmission through a 300 m length of 62.5 micron diameter multimode optical fibre. As the RF power increases, a substantial level of background noise is observed.

Referring to FIG. 3(b), when offset launching is used however, as shown in FIG. 3(b), this noise is suppressed and the signal power is enhanced.

FIG. 4(a) shows noise performance of the fibre (18) for centre launch, and FIG. 4(b) for offset launch. The key used for FIG. 4(a) is also appropriate to FIG. 4(b). By comparing, it can be seen that substantial improvements in the noise performance of the link are observed for all fibres when using offset launch, particularly at higher signal powers. The use of high powers is particularly important in ensuring good dynamic range. (transmitted NRZ signal voltage swing=2Vpp).

FIG. 5 (a) shows the measured error vector magnitude (EVM) of a transmitted 32-QAM RF signal in the presence of a 1.25 Gbps NRZ signal (NRZ signal voltage swing=1.26Vpp) at different RF signal powers for a range of multi mode fibre, each 300 m in length, using centre-launch. FIG. 5(b) shows a similar measurement for offset-launch. A dramatic improvement in EVM is observed for offset launch, this highlighting the importance of the launch in suppressing additional noise features when used for multiservice transmission. In this case fibre 0 is a 2 m patch-cord. The power of the NRZ-signal is held constant.

FIG. 6 shows the principle of degradation mechanism in single RF fibre-optic system, using centre-launch condition: (a) best case and (b) worst case. Depending on the exact launch, the received signal amplitude can drop by up to 50 dB, causing the signal to noise ratio (SNR) to decrease. This effect is not observed when using a launch offset to the fibre axis. As shown, large variations are found in the received power under centre launch between best and worst cases.

FIGS. 7(a) and 7(b) show the principle of RF signal degradation mechanism in multiservice fibre-optic system when using centre-launch: FIG. 7(a) is for low aggregated power in fibre and FIG. 7(b) is for medium to high aggregated power in fibre. Independent of exact launch condition the received noise power increases as the overall power in the fibre increases, causing the SNR to increase. Using offset launch, this effect is only observed at much higher powers. As shown, large variations are found in the received power and background noise levels under centre launch between best and worst cases.

FIGS. 6 and 7 demonstrate the problems with centre launch, and how it affects the signal quality for single RF and multiservice (multiple RF and/or baseband/RF) transmission. As noted above, the problems are mitigated by offset launch. For networks involving the transmission of a single carrier, the impact of offset launching is to maintain a strong fundamental signal power. In the case of multi-service transmission however, offset launch not only maintains signal power, but also minimises background noise essential for high reliability transmission. In the case of centre launch, whilst in many situations good performance is maintained, in a significant proportion of cases the received signal is degraded. This can result from either of two degradation mechanisms, namely an increase in received noise power or a reduction in received signal power.

It is of course important to assess the degree to which the digital transmission is affected by the introduction of the restricted launch scheme. This is shown in FIGS. 8 and 9.

FIG. 8 shows the difference in eye closure (Q-factor) of 1.25 Gbps NRZ signal between offset and centre launch, in the presence of a 2.5 GHz 32-QAM RF signal. A positive difference means an improvement of offset launch over centre launch. An improvement in transmission performance of the NRZ baseband signal can be observed for all fibre-RF power combinations.

As will be seen in every case the restricted launch results in improved transmission, and in some cases these are substantial.

An example eye diagram of one of these measurements is shown in FIG. 9, which shows the eye-diagram of the received 1.25 Gbp NRZ signal (amplitude=2Vpp) after transmission over one of the fibres in the presence of a 32-QAM RF signal at a carrier frequency of 2.5 GHz, using (a) centre launch and (b) offset launch. The eye-opening increases by approx. 3 dB, when offset launch is used instead of centre launch.

The metrics for quality include, but are not restricted to:
spurious free dynamic range (SFDR);
third order intercept point (IP3);
error vector magnitude (EVM);
Q-factor (eye opening);
bit-error ratio (BER);
and the variability of these parameters over time (to ensure that no outages occur).

Types of graded-index multimode fibre that can be used include, but are not restricted to:
old fibre that has been installed within buildings; including but not restricted to FDDI grade, OM1, OM2 and OM3 fibre types
silica fibre;
plastic fibre;
fibre with multiples splices and/or connectors;
fibre with low specified bandwidth; and
fibre with high specified bandwidth.

Types of optical radiation transmitter include, but are not restricted to:
directly modulated lasers diodes, both edge emitting and vertically emitting
laser diodes with external modulators
laser diodes with integrated modulators
light emitting diodes.

The means of coupling include, but are not restricted to:
a launch from a single or multi transverse mode laser with collimating and focussing bulk optics into a graded-index multimode fibre.
a launch from a laser receptacle package into a graded-index multimode fibre where the axis of the optical output from a single or multi transverse mode laser has been offset from that of the fibre.

Hence it has been demonstrated that use of a restricted launch condition provides clear improvements in performance.

An embodiment of the invention has now been described. The invention itself is not however to be restricted to the described features but instead extends to the full scope of the appended claims. Although the above description focuses on fibre diameters of 62.5 microns, the invention may also be applied to other multi-mode fibres, including for example 50 um diameter and high bandwidth fibres.

1: A method of optical communication using a multimode fibre, the method comprising:
using one or more optical radiation transmitters, coupling optical radiation into the multimode fibre using a launch which restricts the number of modes excited in the fibre such that background noise is suppressed in the demodulated signals, wherein the, or each, optical radiation transmitter is a single- or multi- transverse mode laser transmitter driven by a combination of modulated radio frequency signals and/or baseband signals.

2: The method of claim 1, where the coupling step comprises a launch which is co-linear but at an offset to the fibre axis.

3: The method of claim 1, wherein the or each optical radiation transmitter has a linear frequency response whereby it is responsive to both base band and RF inputs.

4: An optical communication system comprising:
one or more optical radiation transmitters;
a means of coupling optical radiation from the, or each, optical radiation transmitter into a multimode fibre using a launch which restricts the number of modes excited in the fibre such that background noise is suppressed in the demodulated signals; and
a photodetector; wherein the, or each, optical radiation transmitter is a single- or multi-transverse mode transmitter arranged to couple transmission signals into the multimode fibre which signals are combinations of modulated radio frequency signals and baseband signals.

5: The optical communication system of claim 4, where the means of coupling light into the fibre produces a launch which is co-linear but at an offset to the fibre axis.

6: The optical communication system of claim 5, wherein the multimode fibre has a core diameter of 62.5 μm and where the offset distance measured from the centre of the multimode fibre core to the centre of the optical radiation emitted from the transmitter is from approximately 10 μm to approximately 25 μm.

7: The optical communication system of claim 4, wherein the or each optical radiation transmitter has a linear frequency response whereby it is responsive to both base band and RF inputs.

8. (canceled)

9. (canceled)

10. (canceled)

11. (canceled)

12. (canceled)

13. (canceled)

14. (canceled)

15: The optical communication system of claim 4 which employs multimode fibre splitters to split the optical signal on a single multimode fibre to multiple multimode fibres for onward transmission.

16: The optical communication system of claim 4 which employs multimode fibre combiners to combine the optical signals on multiple multimode fibres onto a single or multiple multimode fibres for onward transmission.

17: A device for coupling combinations of modulated radio frequency signals and baseband signals into a multimode fibre using a launch which restricts the number of modes excited in the fibre such that background noise is suppressed in the demodulated signals, the device comprising at least one optical radiation transmitter having a single- or multi- transverse mode and drive circuitry having a first input port for modulated radio frequency signals and a second input port for baseband signals, the drive circuitry being arranged to receive electrical modulated radio frequency signals and baseband signals and to drive the laser transmitter therewith.

18: The device of claim 17, having an optical connector for coupling light into said fibre to produce a launch which is co-linear but at an offset to the fibre axis.

19: The device of claim 18, for a multimode fibre having a core diameter of 62.5 μm, wherein the connector is arranged to provide an offset distance measured from the centre of the multimode fibre core to the centre of the optical radiation emitted from the transmitter between approximately 10 μm and approximately 25 μm.

20: The device of claim 17 wherein the at least one laser transmitter has a linear frequency response whereby it is responsive to both base band and rf inputs.

21: An optical communication system using a multimode fibre wherein optical signals are coupled into the fibre for transmission using a technique which restricts the number of excited propagation modes within the fibre to enable high quality transmission of modulated radio frequency signals and baseband signals.

22: The optical communication system of claim 21 which employs multimode fibre splitters to split the optical signal on a single multimode fibre to multiple multimode fibres for onward transmission.

23: The optical communication system of claims 21 which employs multimode fibre combiners to combine the optical signals on multiple multimode fibres onto a single or multiple multimode fibres for onward transmission.
